(19) United States
(12) Patent Application Publication
(10) Pub. No.: US 2026/0154538 A1
(43) Pub. Date: Jun. 4, 2026

(54) NONLINEAR TENSOR COMPRESSION AND DECOMPRESSION FOR NEURAL NETWORKS

(71) Applicant: Amazon Technologies, Inc., Seattle, WA (US)

(72) Inventors: Mahdi Heydari, Palo Alto, CA (US); Sankalp Dayal, San Mateo, CA (US)

(21) Appl. No.: 18/968,836

(22) Filed: Dec. 4, 2024

(51) Int. Cl. G06N 3/0495; G06F 17/16

(52) U.S. Cl. CPC G06N 3/0495; G06F 17/16

(57) ABSTRACT

Devices and techniques are generally described for nonlinear tensor compression for neural networks. In various examples, a first tensor associated with a first layer of a neural network may be determined. One or more neural processing units of accelerator hardware may generate a first compressed tensor by applying a nonlinear compression function to the first tensor. The first compressed tensor may be stored in a first memory of the one or more computer-readable media. A first operation associated with a second layer of the neural network may be determined, where the first operation uses output of the first layer. The first operation may be performed based on the first compressed tensor.

### BACKGROUND

Machine learning techniques are used to form predictions, solve problems, recognize objects in image data for classification, etc. For example, machine learning techniques may be used to detect objects represented in image data, generate text, images, translate text from one human understandable language to another, etc. In various examples, machine learning models may be improved over time by retraining the models as more or different data becomes available. Accordingly, machine learning techniques are adaptive to changing conditions. Deep learning algorithms, such as neural networks, are sometimes used to detect patterns in data and/or perform tasks.

### BRIEF DESCRIPTION OF DRAWINGS

FIG. 1 is a block diagram of an example machine learning accelerator architecture that may include a compression/decompression component for nonlinear tensor compression and decompression, according to various embodiments of the present disclosure.

FIG. 2 depicts examples of uniform quantization and non-uniform (nonlinear) quantization, that may be used by various systems and techniques of the present disclosure.

FIG. 3 depicts examples of nonlinear compression and decompression functions, in accordance with various examples of the present disclosure.

FIG. 4 depicts an example process for nonlinear tensor compression and decompression for neural networks, in accordance with various aspects of the present disclosure.

FIG. 5 is a block diagram showing an example architecture of a network-connected device that may be used in accordance with various aspects described herein.

FIG. 6 is a block diagram illustrating an example architecture of a compression and decompression component that may be used for nonlinear compression/decompression, in accordance with various aspects of the present disclosure.

### DETAILED DESCRIPTION

In the following description, reference is made to the accompanying drawings that illustrate several examples of the present invention. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Artificial intelligence systems including various machine learning models are currently being developed and deployed for a wide variety of use cases, including generative models such as language models (e.g., large language models (LLMs)), image/video generation models (e.g., latent diffusion models), computer vision models, LLM-based agents, neural network-based classifiers, etc. Such machine learning models can be executed on general purpose processors and/or hardware accelerators using program code written in a specialized programming language such as TensorFlow, PyTorch, etc. The program code is converted into machine instructions by a compiler. In a neural network, the types of computations performed, and the data the computations are performed on, can be different from computations used for other things. For example, neural networks can involve repeated manipulation of large quantities of data representing tensors. The term tensor will sometimes be used herein in accord with its mathematical meaning, but will also sometimes be used herein to refer to stored data representing a tensor or a data structure storing data representing a tensor, e.g. a vector, matrix, or larger dimensional data structure. The term channel will sometimes be used herein to refer to a mathematically defined portion of a tensor, e.g. for a three dimensional tensor characterized as having rows, columns, and sheets (the term sheet is used here instead of the sometimes used term “channel” to avoid confusion), the term channel may refer to a row of a single sheet, a row of all sheets, a column of a single sheet, or a column of all sheets.

In various examples, during inference processing (e.g., by a neural network) data representing weights of the model (e.g., the model's parameter set, learned during training) may be loaded into volatile memory (e.g., static random access memory (SRAM)) for processing by a compute engine (e.g., an engine comprising one or more neural processing units that perform matrix multiplication, vector multiplication, and/or accumulation of the results). Neural networks and/or other machine learning models may have a large number of layers, with each layer potentially having a number of neurons (sometimes referred to as “nodes”). In addition, the neurons in a given layer may be “connected” with neurons in preceding layers, subsequent layers, and/or other layers (e.g., “skip” connections). Each of these connections may be associated with a model weight that may be learned during training. As such, execution of a given machine learning model may require storage of a large number of weight values. If these weight values are stored in full-precision form (e.g., using 32-bits floating point (FP32) data type) the amount of memory required for storage of the weights may quickly become very large. For example, large language models (LLMs) currently employ between a billion and nearly two trillion parameters and the numbers of parameters may continue to expand as new models are developed and trained.

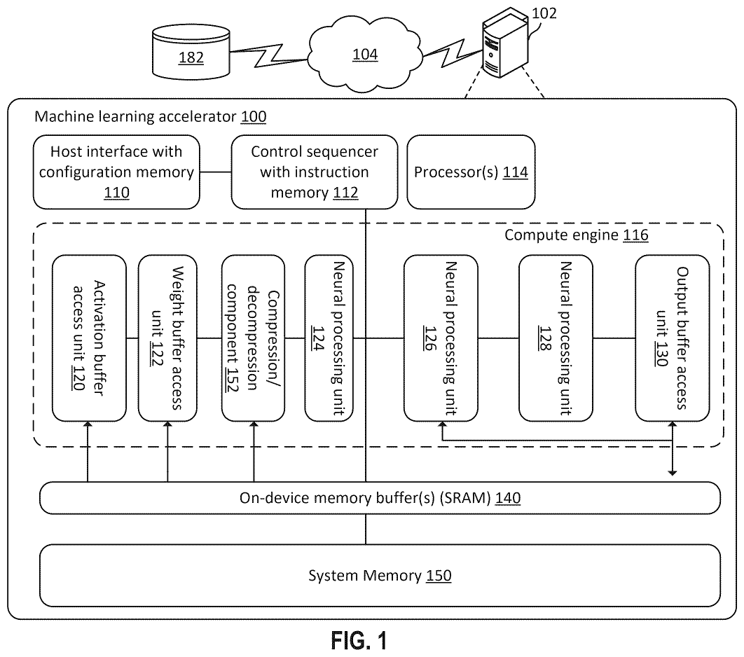

In addition to the large storage requirements of the model weights, many hardware accelerators (e.g., neural network accelerators (NNAs) such as the example described below in reference to FIG. 1) load the model weights into SRAM only when the particular weights are needed for computation. As such, loading full-precision weights from storage (e.g., double date rate (DDR) memory) into on-chip SRAM buffers may involve the movement of a large amount of data leading to both significant processing and power consumption by the NNA. Accordingly, it may be advantageous to compress model weights into quantized reduced-precision weight values and store the reduced-precision weight values in association with the model. For example, if a full-precision model weight is 16 bits, a reduced-precision weight value may be 8 bits, 4 bits, 3 bits, 2 bits, or even 1 bit.

In order to reduce inference cost (e.g., in terms of compute and storage requirements), it may be beneficial to reduce model weight precision. As such, low-bit quantization (e.g., 4-bit weight quantization, 2-bit weight quantization, etc.) may be used to reduce model footprint. The lower the quantization precision (e.g., the higher the amount of compression), the smaller the model footprint. However, lower quantization precision is often associated with an accuracy/performance degradation. Thus, a tradeoff between the quantization and model accuracy may result.

Some machine learning models, such as language models (e.g., “Large Language Models” (LLMs)) may exhibit outlier values in various values used by the model during inference, including tensors of activations, weights, and key-value values (e.g., for calculating attention scores for transformer-based models). Outlier values are values that differ significantly from other data points in the sample. Various statistical methods may be used to quantify outliers. For example, Z-scores, interquartile range (IQR), median absolute deviation, etc., may be used to identify outliers based on the data distribution. Outlier values may be further skewed by nonlinear activation functions present in LLMs and/or other models (e.g., SoftMax) that push such values further apart. For example, in SoftMax, the exponential function in the numerator results in positive outliers skewing the distribution of the output tensor. If the largest value in the input is very large, the outputs corresponding to negative and small positive numbers may all be mapped to 0 at the (uniformly) quantized output (especially for low bit quantization). This can negatively affect the accuracy of the quantized model with quantized activations (e.g., where input and outputs of SoftMax are quantized).

Described herein are various systems and techniques for nonlinear tensor compression and decompression, on-the-fly (during inference), for neural networks. The output tensor (e.g., the output activation tensor) of a given layer of a neural network may be compressed using a nonlinear compression function that compresses values of the tensor in a nonlinear quantization scale. The compressed tensor may be stored in memory (e.g., SRAM) until it is needed for compute (e.g., by the subsequent layer of the neural network). When the compressed tensor is needed during compute, a nonlinear decompression function may be used to convert the compressed tensor back to the linear quantization scale for the next layer to consume. Since it is common in many hardware accelerators for intermediate calculations to use a higher precision tensor, the additional overhead due to such a converted linear scale may be minimal. The nonlinear compression and decompression techniques described herein may be efficiently performed using hardware in an element-by-element manner (e.g., using vector addition circuits (or, more generally, tensor addition circuits) and vector multiplier circuits (or, more generally, tensor multiplier circuits). In addition, software approaches for this on-the-fly nonlinear compression/decompression are also described.

Using nonlinear compression/decompression can significantly improve the accuracy of machine learning models (such as LLMs) when quantized using the same precision (e.g., the same number of bits). For example, an LLM with activations/weights quantized to a first bitwidth employing nonlinear quantization may outperform (in terms of accuracy) the LLM with activations/weights quantized to the same first bitwidth employing linear quantization. The various techniques described herein may be used for both post-training quantization and quantization aware training. However, the techniques described herein may be more beneficial for post-training quantization, as such quantization is more common for LLMs and/or other large models since the cost of retraining/finetuning such models for quantization is high.

In addition, the various nonlinear compression/decompression techniques described herein do not negatively impact latency and/or token generation time of LLMs since the compression/decompression may be done while the weight tensor of the next layer is being loaded from DRAM into SRAM.

A table illustrating the improved accuracy of quantized LLMs is shown below. In the table below, a 7 billion parameter LLM is used, with a KV (key-value) cache size of 128 MB for 16-bit values. If the values are instead compressed to 8-bit values, the memory footprint is reduced by half (e.g., to 64 MB), as shown. In addition, the improvement on inference key performance indicators (KPIs) is also shown in the table (due to nonlinear compression accounting for (instead of clipping) outlier values).

| | Improvement between | Improvement between |
|---|---|---|
| | uniform 16-bit activation | uniform 8-bit activation vs. |
| | vs. 8-bit nonlinear | 8-bit nonlinear activation |
| Metric | activation for 4-bit weights | for 4-bit weights |
| Memory | >64 MB reduction | Similar |
| Memory bandwidth | >64 MB reduction | Similar |
| Tokens per second | Similar (memory bound) | Similar (memory bound) |
| Time to first token (TTFT) | Similar (compute bounds | 5% drop (compute bounds |
| | dependent on prompt length) | dependent on the prompt |
| | | length) |
| Accuracy | 0-2% improvement | 3-4% improvement |
| | (depending on the | |
| | compression function used | |
| | and the outliers) | |

As shown in the table below, nonlinear compression/decompression may maintain and/or improve accuracy even when compared to inference using higher precision (e.g., 16-bit) activations. When the activation precision is the same (with one model using uniformly quantized activations and the other using nonlinear quantized activations) the improvement in accuracy is more drastic. It should be noted that accuracy improvement of LLMs is a tedious task and even a small difference (e.g., less than a percent degradation) in accuracy can lead to a noticeable difference in user experience.

The various machine learning models described herein may be executed on a combination of physical and/or virtualized computing devices/resources. Physical computing resources may include, for example, hardware compute processing units (CPUs), hardware accelerators (e.g., graphics processing units (GPUs), neural processing units (NPUs), neural network accelerators (NNAs), physical memory, etc. Examples of virtualized computing resources may include virtualized CPUs, GPUs, NNAs, virtual memory, etc. Computing resources may include virtualized components executing on physical hardware. In some examples, the virtualized components and/or the physical hardware on which the virtualized components are executed may be distributed (e.g., geographically diverse). A collection of distributed compute services (e.g., of a given server instance) may be instantiated, for example, using a container orchestration framework, one or more virtual machines, physical hardware, etc. In some other examples, a given server instance may executed on the same hardware components (and may not be distributed). Accordingly, server instances may include components that are physical and/or virtual and which may be distributed and/or co-located. A configuration for a given server instance can refer to the different hardware (whether physical or virtualized) deployed on the server instance, the software deployed on the server instance, and/or the configurations thereof.

In various examples discussed herein, some of the computing devices described herein may be provisioned with and/or may employ accelerator hardware. In some cases, machine learning accelerators (and/or general processors, depending on the implementation) may be programmed to implement an inference engine (sometimes called a “compute engine”). An inference engine refers to programming a machine learning accelerator and/or general purpose processor (or processors) to execute the various operations of a particular machine learning model. Examples of such operations may include determining dot products of two vectors, vector addition, vector multiplication, matrix multiplication, forward and backward convolutions, pooling, etc. Inference engines may be implemented using machine learning accelerator hardware and/or other specialized processors (e.g., graphical processing units, tensor processing units).

Hardware accelerators may include a class of specialized hardware accelerators designed to accelerate machine learning applications by focusing on arithmetic operations and in-memory (e.g., in SRAM) computing capability. A neural network accelerator (NNA) architecture is an example of a machine learning accelerator hardware that has been designed to accelerate processing for neural networks. An example of an NNA is described below in reference to FIG. 1. A variety of different operations may be performed by a particular machine learning model during inference. As an example of machine learning operations (e.g., operations that may be optimized to improve performance using the various hardware and/or techniques described herein), a forward pass of a feed forward neural network is now described.

The forward pass involves a series of mathematical transformations that start at the input layer, propagate through one or more hidden layers, and culminate in the output layer. Input data, usually in the form of vectors (e.g., a numerical encoding of one or more inputs token representing words or sub-words, in the context of language models), is provided to the input layer of the model. In a fully-connected example, each neuron of the input layer is connected to each neuron of the subsequent first hidden layer. For each neuron of the input layer, the value is multiplied by a respective weight (a parameter learned during training). The weight value for a given input neuron is specific to that neuron's connection with a given neuron in the first hidden layer. For a given neuron in the first hidden layer, the weighted inputs are summed together and a bias term is added. The bias term allows the activation function to be shifted to the left or right (e.g., to be more negative or more positive). This summation result may be passed through an activation function (e.g., sigmoid, a rectified linear units (ReLu) function, tanh, etc.) to introduce non-linearity into the model. The resulting value is the activation value for the first neuron in the first hidden layer. This process is repeated for each neuron in the first hidden layer. Note that the weight values connecting nodes in the input layer may be different for each distinct neuron in the first hidden layer (and similarly for the connections between subsequent hidden layers and the output layer). As described herein, these weight values may be stored in quantized reduced-precision form (e.g., after compression using nonlinear compression techniques described herein). The quantized weight vectors may be decompressed to generate the full-precision weight values which may be used by the compute engine to compute activation values during the forward pass (as described above).

The activation values for the neurons at the first hidden layer (and similarly for any hidden layer and the output layer) may be stored together in a data structure referred to herein as an activation tensor. In an activation tensor, each element may correspond to a neuron and the value of that element may be the current activation value for that neuron (generated for the current input). Since the inputs may be dynamic, these activation values change over time and are thus dynamic. However, activation values (and activation vectors, matrices, and/or tensors) may also be compressed and/or quantized using the various techniques described herein. Indeed, in some examples, nonlinear activation functions (such as SoftMax, Gaussian Error Linear Unit (GLU), etc.) may introduce outlier values into activations, which, when linearly (i.e., uniformly) quantized can lead to skewed output values. Accordingly, the nonlinear quantization of activation tensors, as described herein, may be especially beneficial for activation tensors when nonlinear activation functions are being used in the model.

As previously described, some current LLM architectures include over a trillion learnable parameters (e.g., weights). As such loading all of these weights into random access memory (e.g., SRAM) during processing involves loading a large amount of data into memory. The various nonlinear compression/decompression systems and techniques described herein may dynamically reduce the amount of data that is required to be stored (e.g., in DDR) by storing compressed representations of the weight tensors. Additionally, the amount of data loaded from storage (e.g., DDR) to memory (e.g., SRAM) may be dramatically reduced by loading only compressed weight tensors before decompressing in on-device memory. Accordingly, the various techniques described herein lead to huge improvements in memory footprint, compute, throughput, and power consumption.

Machine learning techniques, such as those described herein, can be used to form predictions, solve problems, answer questions, recognize objects in image data for classification, generate images, video, and/or natural language data, etc. In various examples, machine learning models may perform better than rule-based systems and may be more adaptable as machine learning models may be improved over time by retraining the models as more and more data becomes available. Accordingly, machine learning techniques can adapt to changing conditions.

Generally, in machine learning models, such as neural networks, after initialization, annotated training data may be used to generate a differentiable cost or “loss” function that describes the difference between expected output of the machine learning model and actual output. The parameters (e.g., weights and/or biases) of the machine learning model may be updated to minimize (or maximize) the cost. For example, the machine learning model may use a gradient descent (or ascent) algorithm to incrementally adjust the weights to cause the most rapid decrease (or increase) to the output of the loss function. The method of updating the parameters of the machine learning model is sometimes referred to herein as back propagation.

As previously described, the compute cost (in terms of compute resources used) for a given inference request may vary greatly depending on the complexity of the request and the particular machine learning model being deployed. Some examples of machine learning architectures which may be deployed for inference processing are now described. It should be noted that these examples do not constitute an exhaustive list and that the inference routing and/or complexity classification techniques described herein may be used with any desired machine learning model architectures.

### Language Models

A generative LM is an artificial intelligence (AI) model that may be capable of processing and generating human-like text based on the latent information it has learned from vast amounts of training data. In some cases, some LMs are referred to as “large” language models (LLMs). The term “large” refers to the size of these models in terms of the number of parameters or weights, which are the values that the model learns during training to make predictions and/or generate output such as text, synthesized speech, control instructions for control of other devices, etc. LMs may have millions, billions (or even more) parameters, which enable such models to capture complex patterns and nuances in language that, in turn, allow the models to process and generate more natural-sounding text (relative to previous approaches). LMs are typically trained on massive datasets that include a wide variety of text from various sources, enabling the LMs to “understand” grammar, context, and the relationships between words, sentences, paragraphs, etc. Examples of LMs include the generative pre-trained transformer models (e.g., GPT-3, GPT-4), Pathways Language Model (PaLM), Large Language Model Meta Artificial Intelligence (LLaMA), Claude by Antrhopic, as well as non-generative examples such as BERT (bidirectional encoder representations from Transformers), etc.

In a generative context, an LM may generate text that is responsive to the input prompt provided to the LM. LMs excel at generating natural sounding text that appears as though it has been generated by a native speaker in the relevant language. In addition to fluency, generative LMs are able to generate detailed, relevant, and largely accurate responses to input prompts in many cases due to the large amount of latent information the generative LM has learned during training. The term “prompt” may refer to plain text or structured text, and may be provided via an interface to the LM, such as an API. The prompt may generally be written in natural language, expressed, for example, as if requesting a task to be performed by the LM (e.g., “Who is the current President of the United States?”). In some examples, contextual information may be provided (e.g., as part of the prompt) and/or may be retrieved (e.g., from external sources) by the LM (e.g., retrieval-augmented generation (RAG)) and used to respond to the prompt). In some examples, LMs may be instructed (e.g., using hidden prompts) as to how to use various external APIs and/or tools (e.g., online search engines and/or other software) that may, in turn, be used to perform actions responsive to user-input requests. LMs are often built using the transformer architecture, which is described in further detail below. It should be noted, however, that transformers may be used in other machine learning contexts beyond LMs.

### Transformer Models

Transformer models are employed in many different types of machine learning architectures, including many of the LMs previously described. Transformer models are machine learning models that include an encoder network and a decoder network. The encoder takes an input (e.g., a “prompt”) and generates feature representations (e.g., feature vectors, feature maps, etc.) of the input. The feature representation is then fed into a decoder that may generate an output based on the encodings. In natural language processing, transformer models take sequences of words as input. A transformer may receive a sentence and/or a paragraph (or any other quantum of text) comprising a sequence of words as an input.

The encoder network of a transformer comprises a set of encoding layers that processes the input data one layer after another. Each encoder layer generates encodings (referred to herein as “tokens”). These tokens include feature representations (e.g., feature vectors and/or maps) that include information about which parts of the input data are relevant to each other. Each encoder layer passes its token output to the next encoder layer. The decoder network takes the tokens output by the encoder network and processes them using the encoded contextual information to generate an output (e.g., the aforementioned one-dimensional vector of tokens). The output data may be used to perform task-specific functions and/or generate a natural language response to the input (depending on the specific model being employed). To encode contextual information from other inputs (e.g., combined feature representation), each encoder and decoder layer of a transformer uses an attention mechanism, which for each input, weighs the relevance of every other input and draws information from the other inputs to generate the output. Each decoder layer also has an additional attention mechanism which draws information from the outputs of previous decoders, prior to the decoder layer determining information from the encodings. Both the encoder and decoder layers have a feed-forward neural network for additional processing of the outputs, and contain residual connections and layer normalization steps.

### Scaled Dot-Product Attention

The basic building blocks of the transformer are scaled dot-product attention units. When input data is passed into a transformer model, attention weights are calculated between every token simultaneously. The attention unit produces embeddings for every token in context that contain information not only about the token itself, but also a weighted combination of other relevant tokens weighted by the attention weights.

Concretely, for each attention unit the transformer model learns three weight matrices; the query weights W_{Q}, the key weights W_{K}, and the value weights W_{V}. For each token i, the input embedding xᵢ is multiplied with each of the three weight matrices to produce a query vector qᵢ=xᵢ W_{Q}, a key vector kᵢ=xᵢ W_{K}, and a value vector vᵢ=xᵢ W_{V}. Attention weights are calculated using the query and key vectors: the attention weight aᵢⱼ from token i to token j is the dot product between qᵢ and kⱼ. The attention weights are divided by the square root of the dimension of the key vectors, \sqrt{dₖ}, which stabilizes gradients during training. The attention weights are then passed through a softmax layer that normalizes the weights to sum to 1. The fact that W_{Q} and W_{K} are different matrices allows attention to be non-symmetric: if token i attends to token j, this does not necessarily mean that token j will attend to token i. The output of the attention unit for token i is the weighted sum of the value vectors of all tokens, weighted by aᵢⱼ, the attention from i to each token.

The attention calculation for all tokens can be expressed as one large matrix calculation, which is useful for training due to computational matrix operation optimizations which make matrix operations fast to compute. The matrices Q, K, and V are defined as the matrices where the ith rows are vectors qᵢ, kᵢ, and vᵢ respectively.

$$Attention ( Q , K , V ) = soft max ( \frac{{QK}^{T}}{\sqrt{{d}_{k}}} ) V$$

### Multi-Head Attention

One set of (W_{Q}, W_{K}, W_{V}) matrices is referred to herein as an attention head, and each layer in a transformer model has multiple attention heads. While one attention head attends to the tokens that are relevant to each token, with multiple attention heads the model can learn to do this for different definitions of “relevance.” The relevance encoded by transformers can be interpretable by humans. For example, in the natural language context, there are attention heads that, for every token, attend mostly to the next word, or attention heads that mainly attend from verbs to their direct objects. Since transformer models have multiple attention heads, they have the possibility of capturing many levels and types of relevance relations, from surface-level to semantic. The multiple outputs for the multi-head attention layer are concatenated to pass into the feed-forward neural network layers.

Each encoder comprises two major components: a self-attention mechanism and a feed-forward neural network. The self-attention mechanism takes in a set of input encodings from the previous encoder and weighs their relevance to each other to generate a set of output encodings. The feed-forward neural network then further processes each output encoding individually. These output encodings are finally passed to the next encoder as its input, as well as the decoders.

The first encoder takes position information and embeddings of the input data as its input, rather than encodings. The position information is used by the transformer to make use of the order of the input data. In various examples described herein, the position embedding may describe an order of a sequence of words.

Each decoder layer comprises three components: a self-attention mechanism (e.g., scaled dot product attention), an attention mechanism over the encodings, and a feed-forward neural network. The decoder functions in a similar fashion to the encoder, but an additional attention mechanism is inserted which instead draws relevant information from the encodings generated by the encoders. In a self-attention layer, the keys, values and queries come from the same place—in the case of the encoder, the output of the previous layer in the encoder. Each position in the encoder can attend to all positions in the previous layer of the encoder. In “encoder-decoder attention” layers (sometimes referred to as “cross-attention”), the queries come from the previous decoder layer, and the keys and values come from the output of the encoder. This allows every position in the decoder to attend over all positions in the input sequence. The decoder is attending to the encoder features.

The foregoing examples of machine learning processing tasks are merely examples to show the diversity (in terms of both the task and the complexity) of machine learning techniques. However, the nonlinear compression and decompression hardware and techniques described herein may be used with any machine learning tasks.

FIG. 1 is a block diagram of an example machine learning accelerator 100 that may include a compression/decompression component 152 (e.g., a compression and decompression component) for nonlinear tensor compression and decompression, on-the-fly (e.g., online, during inference), according to various embodiments of the present disclosure. In various examples, one or more computing devices 102 may include and/or be used to execute the machine learning accelerator 100 and/or components thereof. Additionally, the various components of the one or more computing devices 102 implementing machine learning accelerator 100 may be a collection of compute services that are distributed in a cloud-based environment. The components of machine learning accelerator 100 may communicate with one another and/or with remote computing devices (such as the various server instances discussed herein) via a network 104. Network 104 may be a wide area network, such as the Internet, an intranet, a local area network (LAN), and/or some combination thereof. Non-transitory computer-readable memory 182 may store instructions that, when executed by one or more processors of the one or more computing devices 102 may be effective to instantiate the various components of machine learning accelerator 100 and/or perform the various techniques described herein. In various examples, the machine learning accelerator 100 may include and/or be configured in communication with system memory 150 (e.g., flash, double data rate (DDR) memory, etc.) that may store the weight vectors (and/or any other weight data structures such as matrices, tensors, etc.) of one or more trained machine learning models. The weight tensors may be quantized, post-training, using any desired quantization algorithm to low bit width (e.g., 1 bit, 2 bits, 3 bits, 4 bits, etc., depending on the desired quantization level). For example, the weight tensors may be compressed offline, using nonlinear tensor compression and decompression techniques (e.g., by compression/decompression component 152). The system memory 150 may store quantized weight vectors and/or quantized weight tensors that may be loaded into the on-device memory buffer(s) 140 when needed by the compute engine 116. Although system memory 150 is shown and described, any suitable memory (e.g., DRAM, flash, DDR, etc.) may be used in accordance with the particular machine learning accelerator 100 hardware.

The machine learning accelerator 100 is one example instantiation of a hardware accelerator that may be used to perform highly-parallelized computations that may be typical of machine learning inference, training, and/or testing (e.g., matrix multiplication, tensor products, etc.). However, it should be noted that other types of accelerator hardware may also be used (and/or may be used in combination with the machine learning accelerator 100) in accordance with the present disclosure. For example, graphics processing units (GPUs), tensor processing units (TPUs), field-programmable gate arrays (FPGAs), neural processing units (NPUs), application-specific integrated circuits (ASICs), inference accelerators, etc., may be used in various server instance configurations described herein.

The machine learning accelerator 100 (e.g., a neural network accelerator, GPU, etc.) comprises a host interface 110, a control sequencer 112, an optional processor 114 (e.g., one or more CPUs with any number of cores), an activation buffer access unit 120, a weight buffer access unit 122, a compression/decompression component 152, a plurality of neural processing units (NPUs) 124, 126, and 128, an output buffer access unit 130, a set of on-device memory buffers 140, and storage (e.g., system memory 150). The activation buffer access unit 120, the weight buffer access unit 122, the compression/decompression component 152, the NPUs 124, 126, and 128, and the output buffer access unit 130 collectively form a compute engine 116. However, in some examples, the compression/decompression component 152 may be implemented outside of the compute engine 116 (e.g., as a separate component configured in communication with on-device memory buffer(s) 140 and/or system memory 150. Along with the control sequencer 112, the compute engine 116 is responsible for executing instructions. Although a neural network accelerator (machine learning accelerator 100) is shown and described in the examples of FIG. 1, the nonlinear tensor compression and decompression techniques described herein may be used with any machine learning hardware accelerator and/or with a general purpose processor (e.g., using software).

The machine learning accelerator 100 can be implemented as a standalone computing system or, as shown in FIG. 1, as part of a computing system comprising a host processor and system memory 182. The machine learning accelerator 100 depicted in FIG. 1 is merely an example and is not intended to unduly limit the scope of claimed embodiments. One of ordinary skill in the art would recognize many possible variations, alternatives, and modifications. For example, in some implementations, machine learning accelerator 100 may have more or fewer components than those shown in FIG. 1, may combine two or more components, or may have a different configuration or arrangement of components. The machine learning accelerator 100 generally executes one set of instructions at a time. This set of instructions is referred to herein as a “context.” At runtime, the machine learning accelerator 100 sequences and dispatches, using control sequencer 112, instructions from a pre-compiled context for execution. In certain embodiments, each context comprises a set of instructions that ends with a HALT instruction. Contexts are created by a software compiler. The instructions within a context can implement at least part of a neural network. For example, a context can correspond to a complete layer, a partial layer, or multiple layers of the neural network. In some instances, a context can correspond to a complete neural network (e.g., with instructions for an input layer, a hidden layer, and an output layer).

The host interface 110 is a communication interface to the host processor (not depicted) of the computing system. The computing system includes system memory for storing data operated on by the machine learning accelerator 100 (e.g., weights, activations, and output values corresponding to inferences). The machine learning accelerator 100 may be communicatively coupled to multiple hosts simultaneously, with any one of the hosts being able to program the machine learning accelerator 100 to execute neural network-related tasks on behalf of the host. The host interface 110 can communicate with the host processor via a standard communication protocol such as, for example, Advanced extensible Interface (AXI) protocol. Similarly, the machine learning accelerator 100 can include a separate communication interface for communicating with the on-device memory buffer(s) 140 and/or the system memory 150, e.g., to read and write data from the on-device memory buffers 140 to the system memory 150.

The control sequencer 112 is responsible for sequencing, dispatching, and finishing execution of instructions. Some instructions are executed entirely in the control sequencer 112. Other instructions may be dispatched to one or more of the NPUs 124, 126, and 128 for execution, possibly with execution results being returned to the control sequencer 112 for further processing. Still other instructions may be executed by the compression/decompression component 152 to nonlinearly compress the weight and/or activation tensors (or KV cache, depending on the desired implementation). More than one instruction can be in the execution phase at any given time within the machine learning accelerator 100. The control sequencer 112 can include an instruction memory into which instructions to be executed by the machine learning accelerator 100 are downloaded from the host processor or loaded from the system memory. In the example of FIG. 1, the host interface 110 includes a configuration memory. The configuration memory may include one or more registers that are configurable by the host processor to specify parameters relating to the context to be executed, e.g., various context dependent parameter registers (CDPRs).

In certain embodiments, the configuration memory includes a predicate register for synchronizing execution of instructions. Instructions are broadcast by the control sequencer 112 to each component of the compute engine 116 as well as the on-device memory buffers 140 and the system memory 150. Upon receipt of a broadcast instruction, a component may proceed to execute at least part of the instruction in response to determining that the component is capable of handling the instruction. For example, the system memory 150 could receive and execute a data move instruction, but the NPUs 124, 126, and 128 could ignore the data move instruction. Because instructions can execute concurrently in different components, it is useful to have a synchronization mechanism to handle any dependencies between instructions. The predicate register can be used to implement such a synchronization mechanism and, in certain embodiments, is a global register visible to internal components of the machine learning accelerator 100, as well as visible to external entities such as the host processor. Synchronization also helps to prevent conflicts in accessing the on-device memory buffers 140.

The processor 114 is an optional general purpose processor for performing certain types of processing in parallel with processing performed by the NPUs 124, 126, and 128. For example, processor 114 may include a floating point unit or other arithmetic logic unit for performing general arithmetic operations in parallel with tensor (e.g., matrix) operations performed by the NPUs 124, 126, and 128.

The activation buffer access unit 120 is configured to access one or more activation buffers in the on-device memory buffers 140. In various examples, the activation buffer access unit 120 may access the decoded full-precision activation vectors decoded by the compression/decompression component 152 using the various techniques described herein.

Similarly, the weight buffer access unit 122 and the output buffer access unit 130 are configured to access one or more weight buffers and one or more output buffers, respectively. The activations stored in the activation buffer(s) correspond to activations produced by one or more layers of a neural network being executed on the machine learning accelerator 100. The weights stored in the weight buffer(s) are synaptic weights (e.g., model parameters) associated with edges between a node of one layer and a node of another layer. Activation and weights are used for certain computations, including for instructions executed by the compute engine 116. The output buffers can store final results or intermediate results (e.g., partial sums) for access by the host processor or the system memory 150. The NPUs 124, 126, and 128 perform numerical operations using the activations and weights stored in the on-device memory buffers 140. Each NPU is configured to perform all or part of a compute instruction. Although FIG. 1 depicts the NPUs 124, 126, and 128 as block components, the NPUs 124, 126, and 128 are not necessarily identical. For example, the operations of one NPU may differ from the operations performed by another NPU.

The compression/decompression component 152 may be used to nonlinearly compress and/or decompress quantized tensors that are loaded into memory (in association with a particular model layer for which computation is to be performed).

In various examples, the location of the compression/decompression component 152 can vary. For example, in another embodiment, the compression/decompression component 152 (e.g., “in-line” decompression) can be part of the compute engine 116 and is configured to decompress data stored in the on-device memory buffers 140 for input of the decompressed data to one or more of the NPUs 124, 126, and 128. Optionally, on-the-fly compression/decompression may be used to compress/decompress weight values in on-device memory buffer(s) 140 when storing/loading weight values into weight buffer access unit 122.

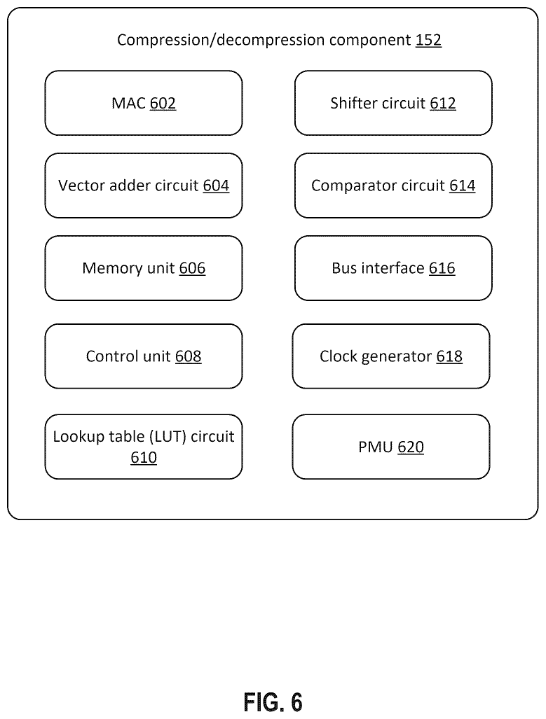

In the example of FIG. 1, the compression/decompression component 152 may be used to nonlinearly compress activation tensors prior to storage in on-device memory buffer(s) 140 (e.g., SRAM) and/or system memory 150 until such tensors are needed by compute engine 116. Similarly, the compression/decompression component 152 may be used to nonlinearly compress weight tensors (e.g., offline) which may be stored in system memory 150. When such tensors are needed, the compressed tensor may be loaded from on-device memory buffer(s) 140 (e.g., SRAM) and/or system memory 150 into the activation buffer access unit 120 and/or the weight buffer access unit 122 (depending on the type of tensor) and may be decompressed by compression/decompression component 152 to convert the nonlinear scale back into a linear scale prior to compute by one or more of the NPUs 124, 126, 128. An example hardware implementation of a compression/decompression component 152 that may be used for element-by-element (e.g., each element of a given tensor) compression/decompression is described below in reference to FIG. 6.

The on-device memory buffers 140 are used to abstract the physical implementation of memories that form the activation, weight, and output buffers from NNA components (e.g., the compute engine 116 and the system memory 150) that access data in these buffers. The data in the activation, weight, and output buffers is accessed through addressing the buffers individually, with the buffer addresses being mapped to the physical addresses of the memories where the data is stored. In certain embodiments, the memories of the on-device memory buffers 140 are implemented as static random-access memory (SRAM) devices. However, the on-device memory buffers 140 can be implemented using other types of memory, both volatile and non-volatile (e.g., flash memory, DRAM, resistive RAMs, and the like). As mentioned above, the data in be stored in the on-device memory buffers 140 in compressed or decompressed form.

The NPUs 124, 126, and 128 perform numerical arithmetic operations using the activations and weights stored in the on-device memory buffers 140. Each NPU is configured to perform all or part of a compute instruction (e.g., operations). The compute instruction may, for example, implement at least some of the computation described earlier in connection with processing by a node of a neural network, i.e., computing a weighted sum of input activations multiplied by weights, adding a bias value to the weighted sum, and then applying an activation function. Other types of computations may also be performed by the NPUs 124, 126, and 128. For example, identifying the minimum and maximum values among a first set of data values represented by a first vector and a second set of data values represented by a second vector, performing an extended multiply add, subtracting two vectors, and other types of operations applicable to data from a vector or matrix may be performed.

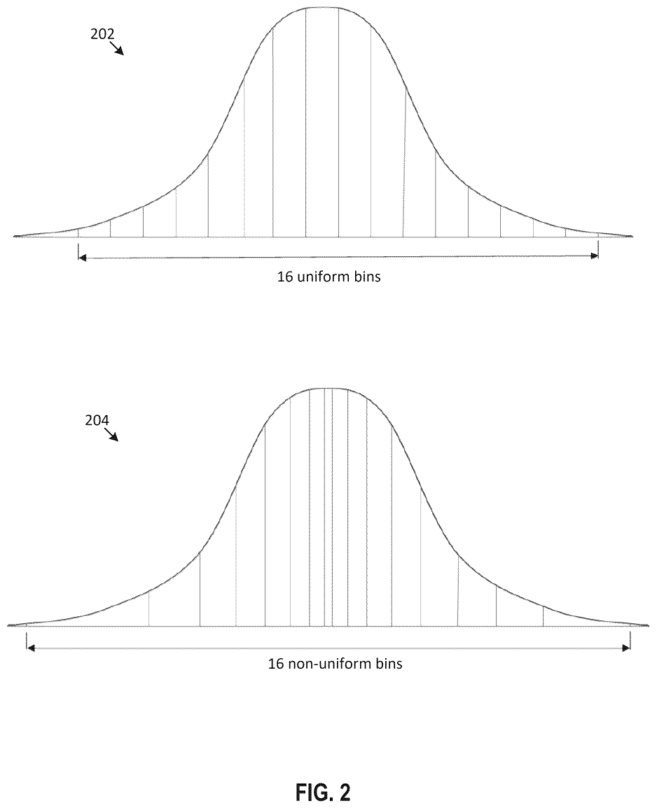

FIG. 2 depicts examples of uniform quantization and non-uniform (nonlinear) quantization, that may be used by various systems and techniques of the present disclosure. In uniform quantization 202, a data range from a minimum value (e.g., the lowest activation/weight value in a set) to a maximum value (e.g., the highest activation/weight value in a set), or some outlier values can first be removed from the set prior to determining the range of values to be quantized. For uniform bins (e.g., linear quantization), the range of values is divided by the number of bins. For example, for 4-bit quantization the range is divided by 24=16 to determine 16 bins of uniform bin width.

For uniform (linear) quantization:

$${x}_{p} = round ( {q}_{x} {x}_{f} - {zp}_{x} )$$

where the scale qₓ and the zero-point zpₓ are both scalar values. The bin width is equal for each bin in uniform quantization. However, as previously described, when outlier values are present, uniform quantization (particularly to low bitwidths) can lead to increased skew and reduced model performance.

In non-uniform quantization 204 (e.g., nonlinear quantization), the bin widths are not consistent across bins. Therefore, non-uniform quantization 204 can better capture outlier values. In some previous approaches for non-uniform quantization (e.g., center lookup table (CLUT), a lookup table may be used to match to a center of each bin. For example, for 16 bins, CLUT matches 0-15 to 16 bin centers. In CLUT, a given tensor is compressed using the corresponding CLUT values 0-15 (e.g., 4-bits per parameter). Then, a compressed tensor is converted to a tensor with the actual values used during compute (e.g., full precision values) prior to computation by the compute engine 116. For example, if the values used by the compute engine 116 are Int16, then each parameter will be converted to a 16-bit bitwidth after decompression. However, using such an approach, a lookup operation is performed for each decompression event to determine the higher-precision value. As such, using CLUT for element-by-element nonlinear compression/decompression may lead to increased processing, latency (e.g., time to first token), and/or power consumption. For these reasons, many conventional nonlinear compression/decompression approaches use block-wise compression/decompression where each block of tensor values uses its own quantization scale factor and zero point to reduce the number of lookups required. In any event, using a CLUT approach for element-by-element compression and/or decompression may incur a large amount of compute and/or latency due to the need to perform a lookup for each element of a given tensor. However, using the various nonlinear compression/decompression techniques described herein, lookups may be avoided while retaining the various advantages of nonlinear compression decompression described herein.

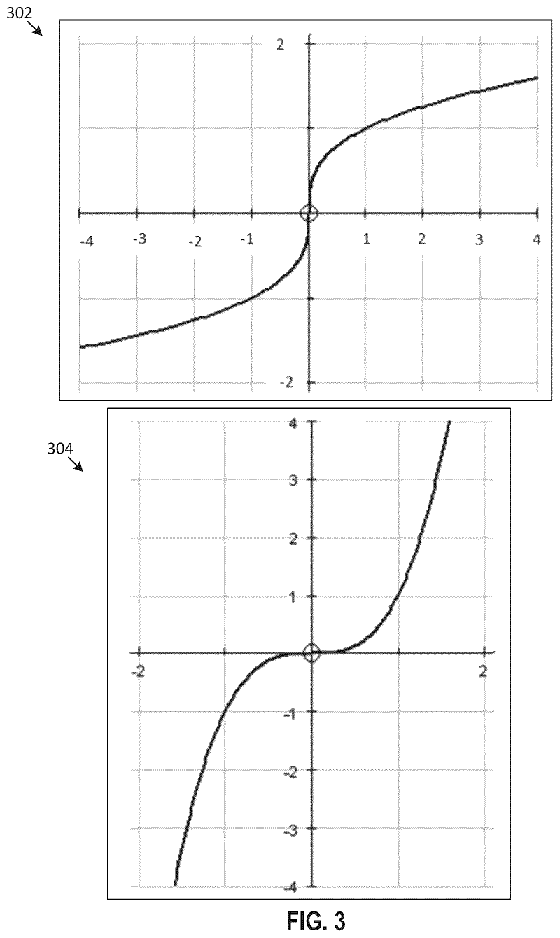

FIG. 3 depicts examples of nonlinear compression function 302 and decompression function 304, in accordance with various examples of the present disclosure. For example, a nonlinear compression function may be determined in order to determine the bin widths for non-uniform quantization.

For example, nonlinear compression/decompression functions can be represented as third degree polynomials:

$$Compression equation \text{:} {x}_{c} = round ( {a}_{3}^{c} {x}_{u}^{3} + {a}_{2}^{c} {x}_{u}^{2} + {a}_{1}^{c} {x}_{u} + {a}_{0}^{c} )$$

$$Decompression equation \text{:} {x}_{u} = round ( {a}_{3}^{d} {x}_{c}^{3} + {a}_{2}^{d} {x}_{c}^{2} + {a}_{1}^{d} {x}_{c} + {a}_{0}^{d} )$$

where xᵤ are uncompressed values, x_{c} are (nonlinearly) compressed values and a represent coefficients for the respective terms of the compression/decompression equations. xᵤ is an argument for the compression equation, whereas x_{c} is an argument for the decompression equation. The coefficients a may be learned as learnable parameters during quantization aware training (QAT). For post-training quantization, the coefficients a may be determined by initializing the coefficients and then using a data sample for calibration by running the model using the initialized coefficients a and without any compression and determining the error between the compressed and the uncompressed outputs. The coefficients a may be adjusted (using techniques such as back propagation and gradient descent) to minimize the error until a convergence is reached. Alternatively, the coefficients a may be estimated by fitting the polynomial over the distribution curve. It should be noted that x_{c} and xᵤ may be of any dimensionality (e.g., individual values, vectors, matrices, higher-dimensional tensors, etc.). Accordingly, the nonlinear decompression/compression may be performed in parallel for each element of the inputs x_{c} and xᵤ as opposed to lookup based approaches which are required to perform individual lookups for each element of the input tensor.

As an example, the input to the compression equation (uncompressed values xᵤ) may be in Int8 precision. The compression equation may compress xᵤ to 4-bit precision (e.g., compressed values x_{c}) and stored (e.g., in SRAM or system memory 150 if SRAM is full). When the compressed values x_{c} are needed (e.g., for computation by an operator of the next layer), the compressed values x_{c} may be converted to their original range using the decompression equation for compute. Note that xᵤ and x_{c} may either be the same or a different precision (e.g., the same bitwidth or different). Even when xᵤ and x_{c} are the same precision, gains in model performance may be realized from the nonlinear quantization (e.g., due to nonlinear quantization better accounting for outlier values relative to uniform quantization). Note that xᵤ and x_{c} may represent any quantum of values (e.g., individual values, vectors, matrices, tensors). Additionally, as previously described, the nonlinear quantization techniques described herein may be used for activation tensors, weight tensors, and/or KV cache. Compute engine 116 may use a higher precision buffer for computing the operation using xᵤ.

In FIG. 3, compression function 302 compresses an input (x-axis) having a range of [−4, 4] to an output (y-axis) range of [−1.5, 1.5]. As shown, this nonlinear compression function 302 increases the resolution near 0 and reduces the resolutions near 4 and −4 to reduce the effect of outlier values. Conversely, decompression function 304 (the inverse of compression function 302) decompresses the input (x-axis) having a range of [−1.5, 1.5] to the original output (y-axis) range of [−4, 4].

In machine learning accelerator 100, it may be the case that compute by compute engine 116 is performed in higher precision relative to input and output precision (of a given layer). As such, the output may be converted into the required precision for compute. Outliers may affect the quantization performance for uniform quantization. This issue may be exacerbated by nonlinear activation functions such as SoftMax that skew the outliers (or large values) further apart.

$$Soft max ( {x}_{i} ) = \frac{exp ( {x}_{i} )}{{\sum }_{j} exp ( {x}_{j} )}$$

This skewing is due to the exponential function in the numerator which results in positive outliers skewing the distribution of the output tensor. If the largest values in the input are very large, the outputs corresponding to negative and small positive numbers may be mapped to 0 at the uniformly quantized output (particularly for low bit quantization). This, in turn, affects the accuracy of the quantized model with quantized activations (e.g., where the input and output of SoftMax are uniformly quantized) since the activations set to 0 have no further effect on the model output.

Accordingly, the nonlinear compression may be used to reduce the outlier effect (and thus preserve model accuracy, especially for post-training quantization). The nonlinear compression function and decompression function may each be vectorized (particularly for polynomials where vector elements can represent individual exponentiated terms of the polynomial). As such, specialized hardware such as the example hardware implementation of the compression/decompression component 152 illustrated in FIG. 6, may be used to speed up performance of the on-the-fly nonlinear compression/decompression relative to block-based CLUT approaches.

A simplified nonlinear compression may be to define a bin width as a₁|x|+a₀ where x is the bin number. This approach may better fit a Gaussian distribution. If the distribution is centered at zero (e.g., for symmetric quantization), it can be assumed that the bin x=0 odes not exist, for simplicity. For exponential distributions (such as the output of SoftMax), x may be equal to 0, 1, 2, . . . , N−1 or 1, 2, . . . , N, where N is the number of bins (e.g., 2ⁿ where n is the number of bits used for representation of the quantized integer tensor).

Note that the nonlinear compression/decompression functions are not limited to polynomials, but may instead take other forms (e.g., trigonometric, exponential, logarithmic). Additionally, the compression and decompression functions may be of different types with respect to one another. In addition, the hardware implementation may support multiple different types of compression and decompression functions.

Another example of a possible compression/decompression function may be a piece-wise linear function. In addition, other piece-wise functions (e.g., piece-wise polynomials) may be used. Additionally, a mixture of different functions may be used in a piecewise manner (e.g., for a given input range a specific function may be used). In regard to improving the quantization and reducing the effect of outlier values, two (or more) consecutive model operations may be combined into a single operation. For example, SoftMax and the following BMM operation (Batched Matrix-Matrix product)—common operations in transformer blocks—may be combined into a single operation. Therefor, the intermediate output (e.g., the output of SoftMax) may be maintained in a higher precision used to calculate the SoftMax output. In this way, processor cycles may be conserved (i.e., the cycles used to convert the intermediate output into a lower precision and later converting back to a higher precision, as described herein).

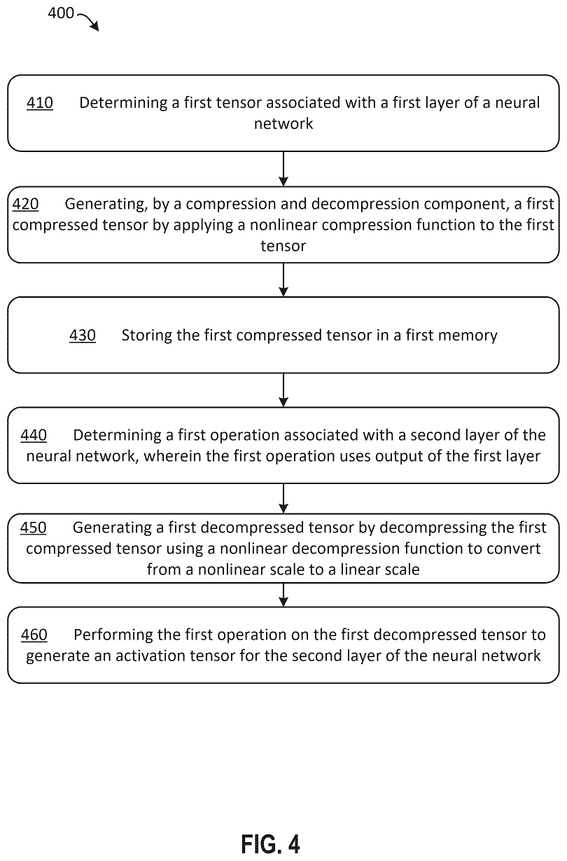

FIG. 4 depicts an example process for nonlinear tensor compression and decompression for neural networks, in accordance with various aspects of the present disclosure. The actions of the process 400 may represent a series of instructions comprising computer readable machine code executable by, for example, compression/decompression component 152, although various operations may be implemented in hardware. In various examples, the computer readable machine codes may be comprised of instructions selected from a native instruction set of the processor(s) and/or an operating system of the computing device.

Process 400 may begin at action 410, at which a first tensor associated with a first layer of a neural network may be determined. The first tensor may be, for example, an activation tensor (e.g., output by a nonlinear activation function such as SoftMax, GeLU, etc.) having full precision output values. In other examples, the first tensor may be a weight tensor associated with the first layer and/or a tensor representing all or some portion of KV cache.

Processing may continue at action 420, at which a compression and decompression component 152 may generate a first compressed tensor by applying a nonlinear compression function to the first tensor. For example, the compression and decompression component 152 may employ hardware (as described below in reference to FIG. 6) to compress the values of the first tensor using a nonlinear compression function (e.g., a polynomial function, a piecewise function, etc.). As previously described, the first compressed tensor may have the same or lower precision as the first tensor.

Processing may continue at action 430, at which the first compressed tensor may be stored in a first memory. For example, after nonlinear compression, the first compressed tensor may be stored in SRAM (e.g., on-device memory buffer(s) 140 and/or at least partially in system memory 150 if the SRAM is full).

Processing may continue at action 440, at which a first operation associated with a second layer of the neural network may be determined. The first operation may use the output of the first layer. For example, the first operation may be computing an activation tensor for the second layer of the neural network. When needed, the first compressed tensor may be loaded into memory (e.g., into SRAM) for compute. As previously described, loading a compressed tensor (e.g., of lower precision) may reduce the amount of data being transferred and may thus conserve memory bandwidth.

Processing may continue at action 450, at which a first decompressed tensor may be generated (e.g., by the compression and decompression component 152) by decompressing the first compressed tensor using a nonlinear decompression function to convert from a nonlinear scale to a linear scale. At action 460, the first operation may be performed on the first decompressed tensor to generate an activation tensor for the second layer of the neural network. For example, after decompression, the full precision activation tensor may be multiplied by the weight tensor for the second layer and the products may be summed to determine the activation tensor for the second layer. Since the first tensor may have included outlier values (e.g., due to a nonlinear activation function applied at or after the first layer) use of on-the-fly nonlinear compression at action 420 may improve model performance relative to uniform quantization.

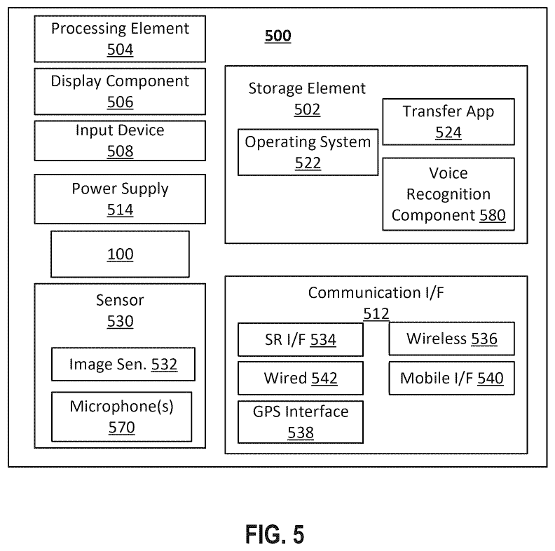

FIG. 5 is a block diagram showing an example architecture 500 of a network-connected device, such as an apparatus that may include the machine learning accelerator 100. In various examples, it may be advantageous to deploy the machine learning accelerator 100 in network edge devices and/or resource constrained devices (such as a device including all or some portion of the components of architecture 500) as the machine learning accelerator 100 may lower computational requirements for model execution (e.g., for machine learning model inference).

It will be appreciated that not all devices will include all of the components of the architecture 500 and some user devices may include additional components not shown in the architecture 500. The architecture 500 may include one or more processing elements 504 for executing instructions and retrieving data stored in a storage element 502. The processing element 504 may comprise at least one processor. Any suitable processor or processors may be used. For example, the processing element 504 may comprise one or more digital signal processors (DSPs). In some examples, the processing element 504 may be effective to determine a wakeword and/or to stream audio data to a speech processing system. The storage element 502 can include one or more different types of memory, data storage, or computer-readable storage media devoted to different purposes within the architecture 500. For example, the storage element 502 may comprise flash memory, random-access memory, disk-based storage, etc. Different portions of the storage element 502, for example, may be used for program instructions for execution by the processing element 504, storage of images or other digital works, and/or a removable storage for transferring data to other devices, etc.

The storage element 502 may also store software for execution by the processing element 504. An operating system 522 may provide the user with an interface for operating the computing device and may facilitate communications and commands between applications executing on the architecture 500 and various hardware thereof. A transfer application 524 may be configured to receive images, audio, and/or video from another device (e.g., a mobile device, image capture device, and/or display device) or from an image sensor 532 and/or microphone 570 included in the architecture 500. In some examples, the transfer application 524 may also be configured to send the received voice requests to one or more voice recognition servers.

When implemented in some user devices, the architecture 500 may also comprise a display component 506. The display component 506 may comprise one or more light-emitting diodes (LEDs) or other suitable display lamps. Also, in some examples, the display component 506 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 506 may be effective to display content determined provided by a skill executed by the processing element 504 and/or by another computing device. In some examples, the display component 506 and/or one or more speakers (not shown) may be effective to output an indication that unconsumed notifications (e.g., voice notifications) are pending. In some cases, there may be an indicator light effective to provide such an indication. In addition, speakers of the architecture 500 may output the voice notification audio upon receiving a user command to consume or “read” the voice notifications.

The architecture 500 may also include one or more input devices 508 operable to receive inputs from a user. The input devices 508 can include, for example, a push button, touch pad, touch screen, wheel, joystick, keyboard, mouse, trackball, keypad, light gun, game controller, or any other such device or element whereby a user can provide inputs to the architecture 500. These input devices 508 may be incorporated into the architecture 500 or operably coupled to the architecture 500 via wired or wireless interface. In some examples, architecture 500 may include a microphone 570 or an array of microphones for capturing sounds, such as voice requests. Voice recognition component 580 may interpret audio signals of sound captured by microphone 570. In some examples, voice recognition component 580 may listen for a “wakeword” to be received by microphone 570. Upon receipt of the wakeword, voice recognition component 580 may stream audio to a voice recognition server for analysis, such as a speech processing system. In various examples, voice recognition component 580 may stream audio to external computing devices via communication interface 512.

When the display component 506 includes a touch-sensitive display, the input devices 508 can include a touch sensor that operates in conjunction with the display component 506 to permit users to interact with the image displayed by the display component 506 using touch inputs (e.g., with a finger or stylus). The architecture 500 may also include a power supply 514, such as a wired alternating current (AC) converter, a rechargeable battery operable to be recharged through conventional plug-in approaches, or through other approaches such as capacitive or inductive charging.

The communication interface 512 may comprise one or more wired or wireless components operable to communicate with one or more other computing devices. For example, the communication interface 512 may comprise a wireless communication module 536 configured to communicate on a network, such as a computer communication network, according to any suitable wireless protocol, such as IEEE 802.11 or another suitable wireless local area network (WLAN) protocol. A short range interface 534 may be configured to communicate using one or more short range wireless protocols such as, for example, near field communications (NFC), Bluetooth, Bluetooth LE, etc. A mobile interface 540 may be configured to communicate utilizing a cellular or other mobile protocol. A Global Positioning System (GPS) interface 538 may be in communication with one or more earth-orbiting satellites or other suitable position-determining systems to identify a position of the architecture 500. A wired communication module 542 may be configured to communicate according to the USB protocol or any other suitable protocol.

The architecture 500 may also include one or more sensors 530 such as, for example, one or more position sensors, image sensors, and/or motion sensors. An image sensor 532 is shown in FIG. 5. An example of an image sensor 532 may be a camera configured to capture color information, image geometry information, and/or ambient light information.

FIG. 6 is a block diagram illustrating an example hardware architecture of a compression and decompression component 152 that may be used for nonlinear compression/decompression, in accordance with various aspects of the present disclosure. The block diagram of FIG. 6 describes various circuitry that may be used, in some examples, to implement the compression and decompression component 152. However, it should be noted that individual components and circuits may themselves be implemented in a variety of ways known to those skilled in the art. Additionally, it should be noted that other hardware implementations are possible with fewer, additional, or different components relative to those shown in FIG. 6. The specific implementation of the compression/decompression component 152 is merely intended to illustrate one example hardware implementation of the compression/decompression component 152 although many other configurations and architectures may be used in accordance with the desired implementation.

Multiplier and accumulator circuit (MAC) 602 may handle both pointwise (element-wise) vector and vector-vector (e.g., dot product) multiplications. MAC 602 may be configured or used in different modes depending on the operation required. For example, when using polynomial nonlinear compression/decompression the MAC may be used for different optional operations, such as:
a) Multiplying polynomial coefficients by indeterminate values (e.g., multiplication of the scalar coefficients by the indeterminate vectors), for example, by multiplying vector xᵤ by the scalar

$${a}_{1}^{c}$$

to get the intermediate tensor of

$${a}_{1}^{c} * {x}_{u} .$$

b) pointwise multiplication of two vectors. This will calculate

$${x}_{u}^{2}$$

by multiplying the vector xᵤ by itself (pointwise multiplication). Then,

$${x}_{u}^{3}$$

can be calculated by multiplying two vectors (e.g., the result of

$${x}_{u}^{2}$$

by xᵤ) using pointwise multiplication.

Note that the specific usage of the MAC 602 may vary according to the specific compression/decompression algorithms being implemented. Some systems might use separate specialized units for different types of multiplications, while others might use a more flexible MAC unit that can handle both operations efficiently. Note that xᵤ may be a matrix (i.e., xᵤ is N×M where N is the token length and M is the hidden layer dimension—e.g., during prompt processing where N>1). During token generation (e.g., by an LLM), N is usually equal to 1. In such cases, the MAC 602 may instead be extended to perform a) and b) on matrices.

Vector adder circuit 604 may add two vectors and/or a scalar added to a vector. For the polynomial example, the terms of the polynomial may be added and partial results may be accumulated using the vector adder circuit 604. For example, xᵤ and x_{c} may be vectors. The vector adder circuit 604 may have two modes:
a) adding a vector and a scalar (e.g., adding the intermediate tensor

$$“ {a}_{1}^{c} * {x}_{u} ”$$

and the scalar a

$${a}_{0}^{c}$$

b) adding a vector and a vector (e.g., adding the intermediate tensors of

$$“ {a}_{1}^{c} * {x}_{u} ” and “ {a}_{2}^{c} * {x}_{u}^{2} ” ) .$$

Note that if xᵤ is a matrix (as described in MAC 602), the vector adder circuit 604 may be extended to perform a) and b) on matrices.

Memory unit 606 may include SRAM and/or registers accessible by the various components of the compression/decompression component 152 (e.g., for storing results and intermediate values). In addition, the memory unit 606 may store coefficient values (e.g., for compression/decompression functions), lookup tables, etc. Control unit 608 may coordinate the operations of other components and may manage the compression/decompression workflow (e.g., by sending machine instructions and/or signals to the various components).

Lookup table (LUT) circuit 610 may be used to store and retrieve pre-computed values for common polynomial operations or other nonlinear functions. Shifter circuit 612 may perform bit-shifting operations for efficient multiplication by powers of 2. Comparator circuit 614 may evaluate conditions and/or thresholds in the compression/decompression algorithm(s). Bus interface 616 may be any physical data linkage that enables transfer of signals between different components of the compression/decompression component 152 and/or external memory (e.g., system memory 150). Clock generator 618 may provide timing signals to synchronize operations across the various hardware components of the compression/decompression component 152. Power management unit (PMU) 620 may regulate power consumption and ensure stable voltage supply to the various components of compression/decompression component 152 (e.g., to prevent brownouts). As previously described, these example components and this particular architecture of a hardware implementation of the compression/decompression component 152 is for illustrative purposes only. Different architectures and/or sets of components may be used in accordance with the various systems and techniques described herein and in accordance with the desired hardware implementation.

Although various systems described herein may be embodied in software or code executed by general purpose hardware as discussed above, as an alternate the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon applying one or more data signals, application specific integrated circuits having appropriate logic gates, or other components, etc. Such technologies are generally well known by those of ordinary skill in the art and consequently, are not described in detail herein.

As used herein (e.g., including in the claims of the application), the terms “first”, “second”, and so forth, do not necessarily imply a particular order of events or elements, but are used to distinguish individual elements from one another. For example, the language a “first layer” of a machine learning model does not necessarily mean that the layer is the initial layer of the model. Instead, the adjective “first” may merely be intended to distinguish the layer from other layers such as a “second” layer. In fact, in various examples, the second layer may precede the first layer and there may be any number of intervening layers between the “first layer” and the “second layer.”

The flowcharts and methods described herein show the functionality and operation of various implementations. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or other type of application described herein that comprises software or code can be embodied in any non-transitory computer-readable medium or memory for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. A system comprising:
a neural network accelerator apparatus comprising:
one or more processors;
a compute engine; and
one or more computer readable media comprising static random access memory (SRAM) and dynamic random access memory (DRAM), the one or more computer readable media storing processor executable instructions which, when executed using the one or more processors, perform operations comprising:
determining, for a first layer of a neural network, a first output tensor comprising at least a first outlier activation value;
generating, by the compute engine using the first outlier activation value as an argument for a nonlinear polynomial compression function, a first compressed output tensor, wherein the nonlinear polynomial compression function is implemented using at least one vector addition circuit and at least one vector multiplication circuit of the compute engine;
storing the first compressed output tensor in the SRAM;
generating, by the compute engine using the first compressed output tensor as the argument for a nonlinear polynomial decompression function, a first decompressed output tensor, wherein the nonlinear polynomial decompression function is implemented using the at least one vector addition circuit and the at least one vector multiplication circuit of the compute engine; and
generating an activation tensor for a second layer of the neural network using the first decompressed output tensor and a first weight tensor associated with the second layer of the neural network.

2. The system of claim 1, wherein the one or more computer readable media store further processor executable instructions which, when executed using the one or more processors, perform operations further comprising:
loading the first weight tensor from the DRAM to the SRAM, wherein the first decompressed output tensor is generated using the nonlinear polynomial decompression function while the first weight tensor is being loaded from the DRAM to the SRAM.

3. The system of claim 1, wherein the one or more computer readable media store further processor executable instructions which, when executed using the one or more processors, perform operations further comprising:
loading the first weight tensor from the DRAM to the SRAM, wherein the first weight tensor has been quantized using the nonlinear polynomial compression function;
generating a decompressed first weight tensor by decompressing the first weight tensor using the nonlinear polynomial decompression function; and
generating the activation tensor for the second layer of the neural network based on multiplying the decompressed first weight tensor by the first decompressed output tensor.

4. A system comprising:
a neural network accelerator apparatus comprising:
one or more processors; and
one or more computer-readable media storing processor executable instructions which, when executed using the one or more processors, cause the neural network accelerator apparatus to perform operations comprising:
determining first tensor data representing output from a first layer of a neural network;
generating, based on a nonlinear compression function and the first tensor data, compressed tensor data representing a compressed version of the output;
storing the compressed tensor data in first memory of the one or more computer-readable media;
loading the compressed tensor data from the first memory;
generating, based on a nonlinear decompression function and the first compressed tensor data, decompressed tensor data representing a decompressed version of the output; and
performing a first operation using the decompressed tensor data.

5. The system of claim 4, wherein the system comprises an electronic device including
a microphone,
a speaker,
a camera,
a system processor,
a wireless communication component, and
the neural network accelerator apparatus.

6. The system of claim 4, wherein the one or more computer-readable media store processor executable instructions which, when executed using the one or more processors, perform further operations comprising:
loading first weight data representing a first weight tensor associated with a second layer of the neural network into static random access memory (SRAM), wherein the first operation is performed using the first weight data.

7. The system of claim 6, wherein the decompressed tensor data is generated while the first weight data is being loaded into SRAM.

8. The system of claim 4, wherein the nonlinear compression function is a polynomial and wherein coefficients of the polynomial were learned for the neural network during quantization aware training.

9. The system of claim 4, wherein the nonlinear compression function is a polynomial, the one or more computer-readable media store processor executable instructions which, when executed using the one or more processors, perform operations comprising:
initializing coefficients of the polynomial;
determining a first output of the neural network for a first sample input, wherein the first output is generated by the neural network without use of the nonlinear compression function for compression;
determining a second output of the neural network for the first sample input, wherein the second output is generated with compression using the nonlinear compression function;
determining first error data based on a difference between the first output and the second output; and
updating the coefficients of the polynomial using the first error data.

10. The system of claim 4, wherein the first tensor data represents a key-value tensor associated with an attention head of the neural network.

11. The system of claim 10, wherein the first compressed tensor data is stored in a key-value cache in dynamic random access memory.

12. The system of claim 4, wherein the one or more computer-readable media store processor executable instructions which, when executed using the one or more processors, perform operations comprising:
loading first compressed weight tensor data representing a compressed version of a first weight tensor associated with a second layer of the neural network into static random access memory (SRAM); and
generating, based on a nonlinear decompression function and the first compressed weight tensor data, decompressed weight tensor data representing a decompressed version of the first weight tensor.

13. A method comprising:
determining a first tensor associated with a first layer of a neural network;
generating, by a compression and decompression component of accelerator hardware, a first compressed tensor by applying a nonlinear compression function to the first tensor;
storing the first compressed tensor in a first memory;
determining a first operation associated with a second layer of the neural network, wherein the first operation uses output of the first layer; and
performing the first operation based on the first compressed tensor.

14. The method of claim 13, comprising generating a first decompressed tensor by decompressing the first compressed tensor using a nonlinear decompression function to convert from a nonlinear scale to a linear scale, wherein the first operation is performed on the first decompressed tensor.

15. The method of claim 14, comprising loading a first weight tensor associated with the second layer of the neural network into static random access memory (SRAM), wherein the first operation is performed based on the first weight tensor.

16. The method of claim 15, wherein the first decompressed tensor is generated while the first weight tensor is being loaded into SRAM.

17. The method of claim 13, wherein the nonlinear compression function is a polynomial and wherein coefficients of the polynomial are learned for the neural network during quantization aware training.

18. The method of claim 13, wherein the nonlinear compression function is a polynomial, the method comprising:
initializing coefficients of the polynomial;
determining a first output of the neural network for a first sample input, wherein the first output is generated by the neural network without use of the nonlinear compression function for compression;
determining a second output of the neural network for the first sample input, wherein the second output is generated with compression using the nonlinear compression function;
determining first error data based on a difference between the first output and the second output; and
updating the coefficients of the polynomial using the first error data.

19. The method of claim 13, wherein the first tensor is a key-value tensor associated with an attention head of the neural network.

20. The method of claim 13, comprising:
loading a first weight tensor associated with the second layer of the neural network into static random access memory (SRAM); and
generating a first decompressed weight tensor by decompressing the first weight tensor using a nonlinear decompression function, wherein the first operation is performed based on the first decompressed weight tensor.
